(19) United States
(12) Patent Application Publication
(10) Pub. No.: US 2007/0142028 A1
(43) Pub. Date: Jun. 21, 2007

(54) System and method for initiating an emergency call from a device to an emergency call processing system

(76) Inventors: Ramy P. Ayoub, Arlington Heights, IL (US); Timothy R. Van Goethem, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 11/313,024

(22) Filed: Dec. 19, 2005

(51) Int. Cl. H04M 11/04

(52) U.S. Cl. 455/404.1

(57) ABSTRACT

A method for dynamically building and maintaining call priority information for use in emergency calls from a client device to an emergency call center is provided. The method provides a plurality of communication connections operable on at least one communication system, and each of the plurality of communication link comprises a plurality of metrics. The method further determines by the client device whether each of the plurality of communication connections is active, and evaluates each of the plurality of metrics for each of the active communication connections, and orders sequentially the plurality of active communication connections based on at least one of the plurality of evaluated metrics.

### FIELD OF THE INVENTION

The present embodiments relate, generally, to communication devices and, more particularly, to a system and a method of initiating an emergency call from a client device to an emergency call processing system.

### BACKGROUND OF THE INVENTION

Emergency response systems, both public and private, have continuously been improving their system response times to emergencies in an effort to provide reliable, quick and accurate emergency assistance to the general public and customers. Emergency call centers have generally implemented redundancy in their call-centers. Cities, towns and public safety organizations have implemented advanced traffic control and navigation abilities to ensure timely responses to emergency situations.

Generally, operating environments in emergencies dictate that minutes, and even seconds may make a difference between life and death to injured persons. A weak link in these emergency response systems has typically been at the points of origination of the emergency calls, such as from vehicles, homes and offices. Most homes, vehicles and offices are vulnerable to damage to or loss of their emergency calling or network access device(s) during emergencies. The calling or network access devices used in vehicles are susceptible to being damaged in a collision, while landline phones and cable connections to homes or offices are often damaged in fires or natural disasters.

Typically, homes or vehicles do not have an integrated redundancy in their emergency calling options, such as landline phones, cellular phones, and voice over Internet protocol (VoIP) that may ensure reliable communications and substantially fast access to emergency calling and response centers, such as 911 for example. Vehicles, homes and offices, however, are now, in growing numbers, hosting multiple communication interfaces, such as WiFi, Bluetooth, digital cable, landline phones and cellular phones. These multiple communication interfaces are, however, beginning to provide similar functionality. For example, one may place voice calls over WiFi networks and digital cable networks in addition to the traditional landline and cellular phone networks. As such, the characteristics of the networks and communications interfaces may differ for a given feature. These characteristics may be captured in the form of communication interface metrics. Critical metrics for emergency call can be classified as connection time, quality of service (QoS) and connection availability. The ability to achieve fast connection times with the highest reliability service may be the difference between life and death in emergency situations.

Current over-the-air protocols may have multiple bearer services to transmit messages from a subscriber to a bearer service center. Generally, a bearer service is determined and selected prior to transmittal of the message and is indifferent to the type of data contained in the message. Moreover, once determined and selected, the transmission is locked to the selected bearer service.

Subscribers may attempt to transmit a data message a fixed number of times until an acknowledgement is provided that the data message was received by the service center. Subscribers initiating the transmission of the messages, however, do not get an acknowledgement after the fixed number of attempt times, and the system may stop further attempts leaving the message unsent.

Subscribers may also attempt to initiate emergency voice calls to a service, or emergency center, and may also not get a response from the service center due to damage to the communication equipment in the vehicle, home or office.

Accordingly, there is a need for addressing the problems noted above and others previously experienced.

### BRIEF DESCRIPTION OF THE DRAWINGS

FIG. 1 is a block diagram of a telecommunications system having client devices and a service center;

FIG. 2 is a block diagram of an embodiment of a client device of FIG. 1;

FIG. 3 is a block diagram of various software layers that may exist in a client device for the system in FIG. 1;

FIG. 4 is a flow chart illustrating a method for building and maintaining priority call information of communication connections;

FIGS. 5a-5f illustrate examples of emergency call priority lists of bearer services; and

FIG. 6 is a flow chart illustrating a method for initiating an emergency call based on current emergency call priority information of communication connections.

Illustrative and exemplary embodiments of the invention are described in further detail below with reference to and in conjunction with the figures.

### DETAILED DESCRIPTION OF THE INVENTION

The present invention is defined by the appended claims. This description summarizes some aspects of the present embodiments and should not be used to limit the claims.

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated. The present invention is defined by the appended claims. This description summarizes some aspects of the present embodiments and should not be used to limit the claims.

In this application, the use of the disjunctive is intended to include the conjunctive. The use of definite or indefinite articles is not intended to indicate cardinality. In particular, a reference to “the” object or “a and an” object is intended to denote also one of a possible plurality of such objects.

One feature is to provide a method for dynamically building and maintaining call priority information for use in emergency calls from a client device to an emergency call center. The method provides a plurality of communication connections operable on at least one communication system, and each of the plurality of communication links comprises a plurality of metrics. The method further determines by the client device whether each of the plurality of communication connections is active, and tests calls on each of the active communication connections. The method evaluates each of the plurality of metrics for each of the active communication connections, and orders sequentially the plurality of active communication connections based on at least one of the plurality of evaluated metrics.

Another feature is to provide a method for communicating an emergency message from a client device to a service center. The method provides a sequentially ordered list of a plurality of communication connections, and attempts to initiate an emergency call, or transmit the emergency message, over a first communication connection selected from the sequentially ordered list of a plurality of communication connections. The proposed method determines whether the emergency message was successfully transmitted to and received by the service center over the first communication connection, and attempts to transmit the emergency message over a second communication connection selected from the sequentially ordered list of a plurality of communication connections if the service center did not receive the emergency message transmitted over the first communication connection. The method then determines whether the emergency message was successfully transmitted to and received by the service center over the second communication connection.

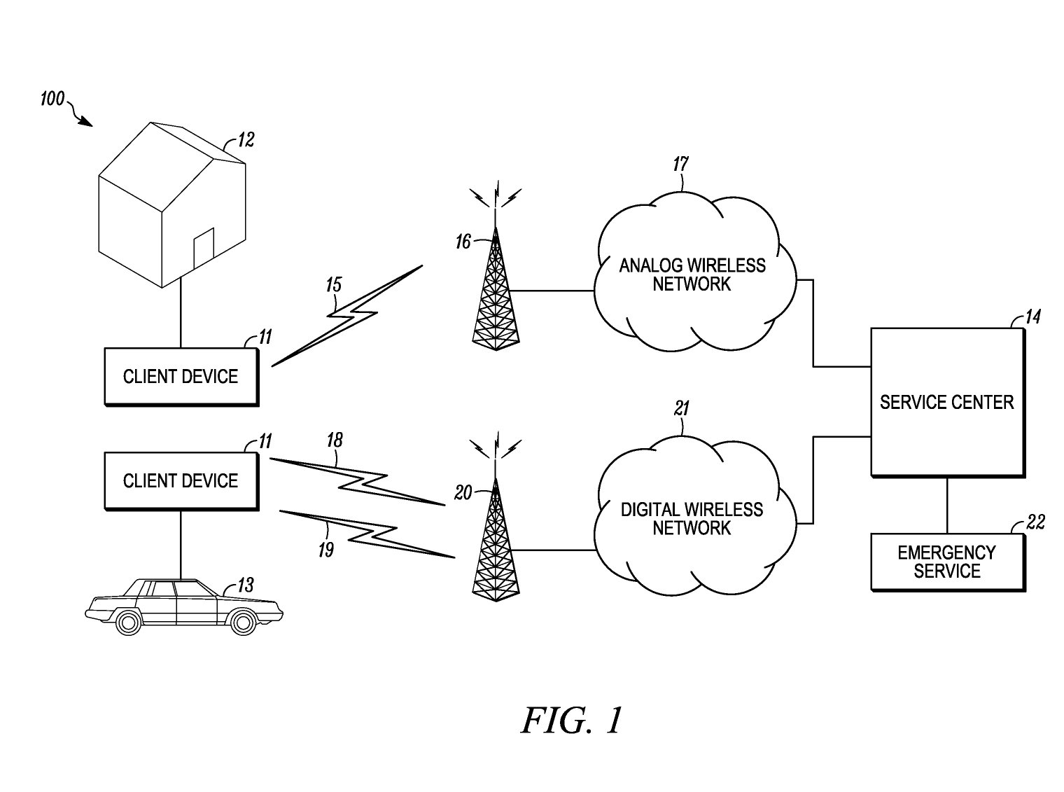

Turning first to FIG. 1, a system level diagram of a communication system 100 is shown. As will be described in detail in reference to later figures, a number of elements of a telecommunication system could employ the methods disclosed in the present application.

Generally, the communication system 100 includes client devices 11 incorporated into a household or business 12 and a vehicle 13, and an emergency service center 14. Although only two client devices 11, the vehicle 13, and the emergency service center 14 are shown, any number of these elements may be implemented to interoperate with each other. The client device in the vehicle 13 may be a Telematics system which may host numerous communication connections.

For the sake of simplicity, only one client device 11 is referred to in the following discussions used as the origin of the emergency call placed to the emergency service center 14. Hereafter, the term “emergency call” includes any voice or message data communication to a service or emergency center. In the telecommunications system 10, the client device 11 is in communication with the emergency service center 14 via a number of wireless communication links 15, 18, and 19, base stations 16 and 20, and analog and digital wireless networks 17 and 21. The wireless communication links 15, 18, and 19 may each represent a type of bearer service of the over-the-air protocols. Different types of bearer services may exist for transmitting data over wireless communications including, but not limited to, a cellular voice service, wireless Ethernet 802.11b (local area network (LAN)) service, general packet radio service (GPRS), short message service (SMS), circuit switched data service (CSD), and high-speed circuit switched service (HSCSD), among others. Moreover, a Bluetooth connection may be available to a Bluetooth capable phone incorporated into the client device 11 or present in the vehicle 13 (e.g., a personal cellular phone of the driver).

The cellular voice service is a bearer service that may use either analog or digital voice signaling protocols. Examples of digital voice signaling protocols include code division multiple access (CDMA), time division multiple access (TDMA), and global system for mobile communications (GSM), among others.

Wireless Ethernet standards 802.11 refer to a family of specifications developed by the IEEE for wireless LAN technology. The 802.11 standards specify an over-the-air interface between a wireless client and a base station or between two wireless clients. The 802.11b wireless LAN bearer service allows the transmission of data over a LAN network, and provides an 11 megabits per second (Mbps) transmission rate, with a fallback to 5.5 Mbps, 2 Mbps and 1 Mbps transmission rates in the 2.4 GHz band using direct sequence spread spectrum (DSSS). The 802.11b bearer service allows a wireless functionality comparable to an Ethernet. Currently, 802.11 communication links to the vehicle 13 are being provided by such systems such as dedicated short range communications (DSRC). DSRC systems are operable in the 5.9 GHz band and are developed to support a wide range of public-safety and private operations in roadside-to-vehicle and vehicle-to-vehicle environments for the transportation industry. DSRC complements cellular communications, where time-critical responses (less than 50 ms) or substantially high data transfer rates (6-54 Mbps) are needed in small zones with license-protected authority, and enables a new class of communications applications that can support future transportation systems and needs.

GPRS is a bearer service that allows the transmission of high-speed data over existing digital communication networks such as the GSM protocol. GPRS supports the Internet Protocol (IP). Use of IP data communication allows the client device 11 to have access to Internet information and applications. GPRS is a type of virtual connection that allows the user to always be connected to a communication network. The transmission rate of GPRS is over about 64 kilobits per second (kbps). Currently, however, the transmission cost of GPRS is typically based on the amount of data that is transmitted and may be more costly compared to other bearer services.

SMS is a bearer service that allows the transmission of data over several types of existing protocols such as GSM, CDMA, and TDMA. SMS enables a client device 11 to transmit short data messages to the emergency service center 14. The time to transfer data in SMS is not as good as transferring data in GPRS. Yet, the transmission cost of transmitting data using SMS is cheaper than GPRS.

CSD is a bearer service that allows the transmission of data over several types of existing protocols such as GSM, CDMA, TDMA, and Advanced Mobile Phone System (AMPS). When transmitting over an analog communication network (such as AMPS), the client device 11 needs a data modem for the wireless transceiver. The transmission rate of CSD is about 9.6 kbps. Currently, the transmission cost of transmitting data using CSD is cheaper than GPRS.

HSCSD is an enhancement of CSD to allow the transmission of data over existing protocols such as GSM. One enhancement includes a new coding scheme with less error protection capabilities. The coding scheme allows the transmission rate to be increased from about 9.6 kbps to 14.4 kbps. Another enhancement includes providing up to four time slots for a single data call. Use of four time slots per data call allows transmission rates varying from 38.4 kbps to 57.6 kbps (depending on whether the bearer is at 9.6 kbps or 14.4 kbps). The above described bearer services are merely representative of existing bearer services that may be used in the present embodiments. Alternately, other bearer services may be used depending on the implementation and geographic location such as those anticipated for digital protocols of Wideband Code Multiple Access/Universal Mobile Telecommunications System (W-CDMA/UMTS) and CDMA2000. The communications between the client device 11 and the service center 14 is now described generally although a more detailed description is provided after the general discussion.

As shown in FIG. 1, in one embodiment, the client device 11 communicates an emergency call during an emergency situation via communication links 15, 18, and 19, through a bearer service over either base station antenna 20 for corresponding digital wireless network 28 or base station 16 for corresponding analog wireless network 21 (depending on the selected bearer service). The emergency call is then transferred to the service center 14 according to known systems such other cellular infrastructure, the Internet, and/or a public switched telephone network (PSTN).

As shown in FIG. 1, in one embodiment, the service center 14 may respond to an emergency message by sending a response or acknowledgement message via communication links 15, 18, and 19 to the client device 11. This response or acknowledgement message informs the client device 11 that the message was received by the service center 14. Depending on the type of message being sent, the service center 14 may further establish a voice communication link with the client device 11 to inform the user that the emergency message was received or to provide other information related to the requested service. In another embodiment, the service center 14 may respond to an emergency voice call, initiated by the user via the client device 11 during an emergency situation. The user hears the proper call sequence and operator voice in the case of a successful call.

Messages from the service center 14 to the client device 11 may be sent over a cellular wireless communication through the digital wireless network 21 and associated base station antenna 20 or through the analog wireless network 17 and associated base station antenna 16. Alternately, other alternate protocols may be used for communications from the service center 14 to the client device 11. In one embodiment, the communication is transmitted through an over-the-air protocol such as CDMA, GSM, TDMA, or AMPS. The transmission from the service center 14 to the client device 11 may also be made by other wireless communications such as satellite communications.

Typically, in response to receiving the message from the client device 11, the service center 14 may act in response to the data contained in the message. For example, if the data contained in the message indicates that the user has an emergency (such as an accident) the service center 14 may contact an emergency service 22 with the location of the vehicle 13. The emergency service 22 may then send the police, fire brigade, and/or medical support as needed to the vehicle location.

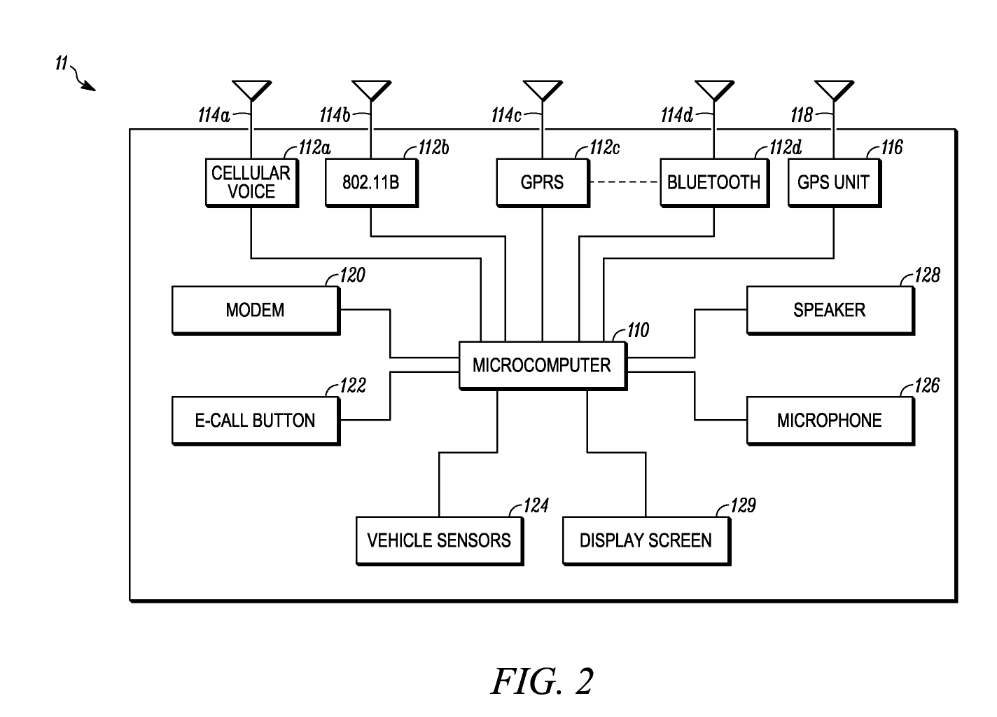

Now referring to FIG. 2, an embodiment of the client device 11 is illustrated. The client device 11 comprises a microcomputer 110 and wireless communication devices or units 112a-112d coupled to respective antennas 114a-114d. The wireless communication devices or units 112a-112d comprise at least the following wireless communication services to improve a communication redundancy of the client device 11: 802.11b, Cellular, GPRS and Bluetooth. Depending on the targeted implementation, the microcomputer 110 and wireless communication devices 112a-112d may be integral parts of the vehicle 13. Alternatively, the microcomputer 110 and wireless communication devices 112a-112d may be separate components included in a device such as a portable Telematics device, cellular or Personal Communication System (PCS), a pager, or a hand-held computing device such as a personal digital assistant (PDA) that is docketed or otherwise connected to a Telematics system within the vehicle 13.

The microcomputer 110 is configured to transmit and receive voice and data communications to and from the service center 14. The client device 11 also comprises a GPS module 116 coupled to an antenna 118, a modem 120 to assist in transmission of data over analog wireless network 17, an emergency call button 122, vehicle sensors 124, a microphone unit 126, a speaker unit 128, and a screen/display unit 129.

Each of the wireless communication devices 112a-112d includes a transmitter to transmit voice and data messages using antenna 114 via an over-the-air protocol such as AMPS, CDMA, GSM or TDMA. The wireless communication devices 112ac-112d may also be configured to transmit by other wireless communications such as satellite communications. As explained above, the transmitter is configured to transmit at least data messages to the service center 14 over a plurality of bearer services. Thus, if the wireless communication devices 112ac-112d are configured to send messages over an analog protocol, they may need a data modem 46.

Each of the wireless communication devices 112a-112d also includes a receiver to receive and decode data messages (including acknowledgements) from the service center 14. Each of the wireless communication device 112a-112d may also include a receiver to receive voice calls from the service center 14. The respective receivers may be configured to receive data and voice calls through an over-the-air protocol such as CDMA, GSM, TDMA, or AMPS. The respective receivers may also be configured to receive other types of wireless communications such as those transmitted by satellites.

The position sensor or GPS module 116 may help the client device 11 to determine and report the location of the vehicle 13. Determining the location of the vehicle 23 may be important in several Telematics applications. For example, when an emergency exists, a message to the service center 24 may contain location data of the vehicle 13 in addition to other data about the emergency.

Vehicle sensors 124 typically assist drivers by providing information on a status of the vehicle 13. Generally, sensors collect relevant information from the vehicle and monitor the immediate traffic environment. These vehicle sensors 124 may monitor collisions, and air bag deployments, among others.

The microphone 126 may be used during voice calls between the client device 11 and the service center 14. The user of the client device 11 in connection with a voice recognition system (not shown) may further use the microphone 126 for voice commands. Telematics application specific buttons, such as the E-Call button 122, may be used to wake an application or otherwise initiate the generation and transmittal of specific data messages to the service center 14. Initiation of data communication may also be accomplished automatically via vehicle sensors, such as air bag sensors.

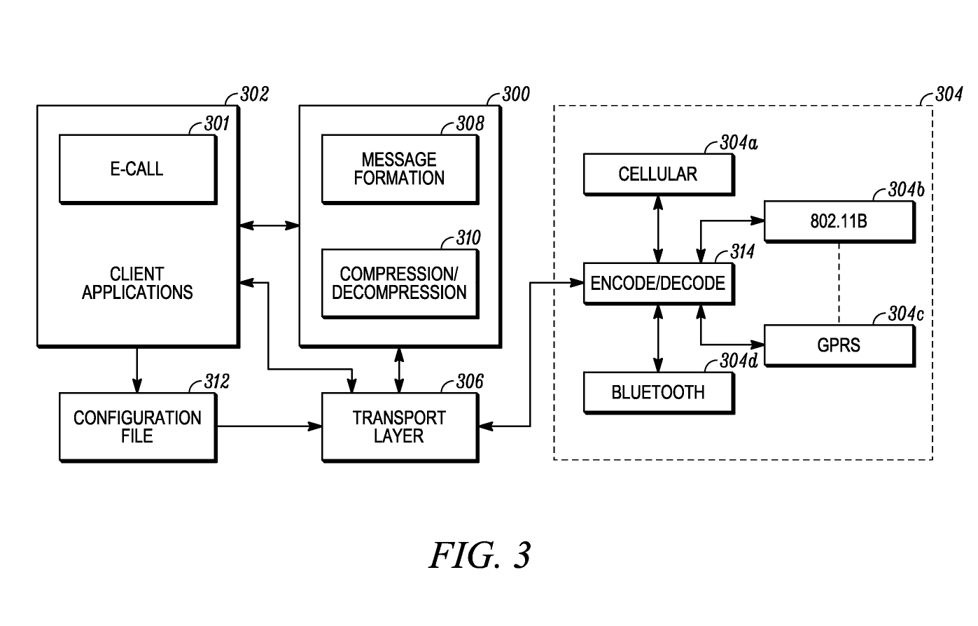

Now referring to FIG. 3, a block diagram illustrates software layers of the client device 11. These software layers may include an application layer 300, a transport layer 302, and a network layer 304. These software layers may be computer modules comprising computer instructions that are stored in a computer-readable medium in the microcomputer 110. Additional layers may be provided as needed, and/or layers that are not needed could be deleted or combined.

The software platform in this embodiment includes layers, each of which is briefly summarized below according to its reference numeral in FIG. 3. In one embodiment, the application layer 300 may have access to a wide variety of client applications 302 specific for the client device 11. For example, the client applications 302 may include Telematics applications such as emergency call 301, among others. As used herein, an “application” is defined as any computer program that provides one or more functions that are of interest to a user of the client device 11.

As such, the emergency call application 301 may be used for notifying the service center 14 of emergencies. For example, the emergency call application 301 monitors the sensors on the vehicle to determine whether the vehicle 13 has been involved in a collision. For example, such a determination may be made by monitoring an airbag deployment sensor or a sensor on one of the bumpers of the vehicle 13. The emergency call application 301 may additionally monitor the E-Call button 122 or other input means that is based on user demand. When an emergency arises, a data message may be generated and provided to the transport layer 306. In one embodiment, the intent of the data message is to notify the service center 14 of the arisen emergency so that the service center 14 may contact an emergency service 22 (such as the police, fire brigade, or medical support).

Thus, the application layer 300 takes information from the client applications 302 (such as Telematics applications) and formats a message for the transport layer 306. The application layer 300 also passes messages from the emergency call application 301, and presents the information in the message to the client applications 300. The application layer 300 may be implemented in a number of ways. In one embodiment, the application layer 300 uses extensible Markup Language (XML) for structuring the data for messages. XML allows for easier generation of data and ensures that the data structure is unambiguous. In this case, the application layer 300 uses a message formation function 308 and compression function 310 to generate messages for presentation to the transport layer 306.

In another embodiment the client applications 302 may be generic telephony applications that are designed to recognize regional emergency call numbers, such as “911” in the Unites States of America or “112” in Europe. By detecting the initiation of calls to these numbers, the client applications 302 may communicate the emergency status directly to the transport layer 306. The transport layer 306 may then provide a variety of tasks such as selecting the type of data or voice bearer service, formatting the data message according to the selected bearer service, and monitoring the voice call initiation to ensure call completion, or monitoring the transmittal of the data message to ensure delivery to the service center 14.

In another embodiment, the transport layer 306 receives the emergency call from the application layer 300 and then accesses certain parameters or metrics from the configuration file 312. The transport layer 306 may select a bearer service based on current parameters or metrics from the configuration file 312. The configuration file 312 may store and update different sequential orders of bearer services. For example, the sequential order of bearer services may be an ordered priority list or information of bearer services based on at least one of their current transmission rates, transmission costs, quality of service (error rates), call setup times, and link up-times, among others.

In one embodiment, the network layer 304 manages and drives the communication devices to ensure that the data message is sent according to the correct bearer service selected by the transport layer 306. For example, the network layer 304 may include an encode and decode function 314 for the data messages. Additionally, the network layer 304 may include additional software needed to drive the communication device to perform the transmittal of the emergency call over one of a plurality of bearer services cellular voice service 304a, 802.11b 304b, GPRS service 304c, and Bluetooth service 304d, among others.

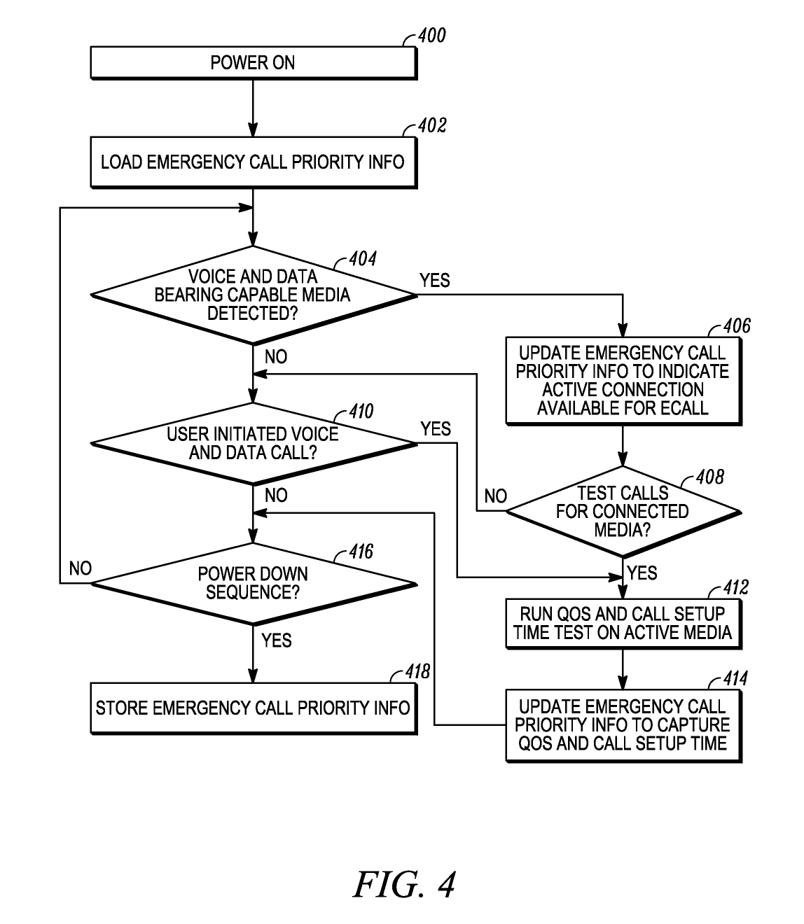

Now referring to FIG. 4, a flow chart illustrating a method performed by the client device 11 for building and updating a call priority list of bearer services is shown. This proposed method monitors all available voice call bearer services, access media capable services, to the client device 11, and continuously monitors and collects critical metrics for each of the available communication bearer services. As stated above, these metrics may comprise transmission rates, transmission costs, quality of service (error rates), call setup times, and link up-times, active link existence, among others.

Initially, these metrics may be provided in the client device 11 in a default emergency call priority table, and reordered, if needed, each time a call is placed over the communication connections or links corresponding to the available bearer services. Moreover, the proposed method may also provide for the ability, to regularly place test calls to measure the metrics of each communication connection. As such, the proposed method may dynamically build and maintain the call priority table during run time to establish the priority of the emergency connections. Alternately, a manufacturer of the client device 11 may specify that the highest priority connection be an Enhanced 911 (E911) cellular call, for example. As known, the wireless E911 system was set up with rules that seek to improve the effectiveness and reliability of the wireless 911 service by providing 911 dispatchers with additional information on wireless 911 calls. The wireless E911 program requires carriers, upon appropriate request by a local public safety answering point (PSAP), to report the telephone number of a wireless 911 caller and the location of the station or cell that received the call. Alternate emergency connection ordering or ranking may be an E911 VoIP 802.11b data call, followed by a GPRS VoIP call, and followed by a Bluetooth connection to a Bluetooth capable phone in the system.

In FIG. 4, in one embodiment, the client device 11 is powered on, either as a stand alone device or with the vehicle 13 when an ignition key is turned to the ON position, at step 400. The emergency call priority table is loaded from a non-volatile memory associated with the configuration file 312, at step 402. The loaded emergency call priority table may be ordered based on the previous capture of the metrics when a call was made from the client device 11. Subsequently, a check is made to determine which of the voice or data bearing services are available, at step 404. In the affirmative, the emergency call priority table is updated to reflect the detected active connections available for emergency calls, at step 406. Further, the proposed method proceeds to test calls on the active media connections, at step 408. If test calls are allowed on that connection, or media, the method runs metrics tests, such as quality of service (QoS) and call setup times, on the active media connections, at step 412, to help update the emergency call priority table to capture the tested metrics, at step 414. Otherwise, the method waits for user initiated voice or data calls, at step 410, to run the metrics tests of step 412. Once, the emergency call priority table is updated with the capture of the tested metrics, and the method has determined that no voice calls have recently been initiated by the user, a check is made as to whether this method is to be powered down, at step 416. In the affirmative, the current call priority table of active connections is stored in the non-volatile memory of the configuration file 312. In the negative, the proposed method continually monitors the communications connections on a periodic basis to have up to date table connection information in the event of an emergency. The method may potentially encompass handling or monitoring event information from the vehicle components as a stimulus for re-testing the communication connections and thereby updating the emergency call priority table. For example, one of the communication devices 112a-112d may report loss of link or connection to the network, as in the case where a GSM subscriber roams outside of a GSM coverage area. Another type of event may be a report from a vehicular diagnostic system reporting that a component is unresponsive.

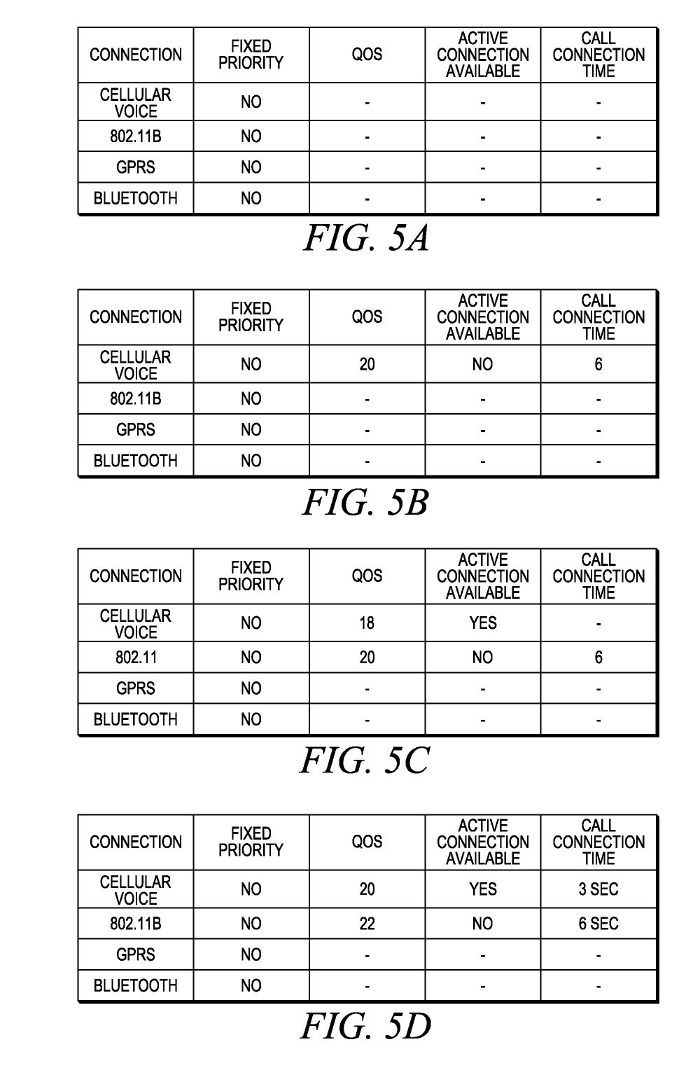

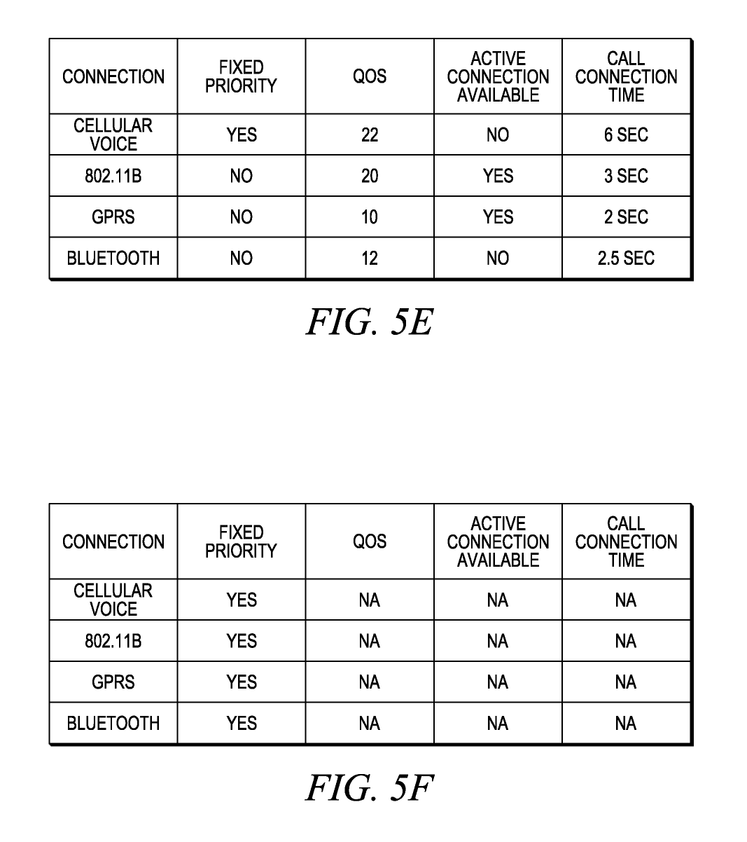

Now turning to FIGS. 5a-5f, examples of emergency call priority tables of bearer services are shown. In addition to a situation where the call priority table has a fixed priority or order, the metrics being considered for this call priority tables are QoS, available active connection, and call connection time. In FIG. 5a, a default emergency call priority table is shown, as shipped by a manufacturer or builder. In this embodiment, where the client device 11 is capable of placing a voice call over bearer services Cellular voice, 802.11b, GPRS and Bluetooth, the default call priority list is initially ordered as follows: the first bearer service may be cellular voice, the second bearer service may be 802.11b, the third bearer service may be GPRS, and the fourth bearer service may be Bluetooth.

After a first cellular voice call is made, the corresponding metrics are captured, as shown in FIG. 5b. Thus, the call priority table gets updated; however no reordering of the bearer services is effected, since the cellular voice connection was listed first by default. Afterwards, as shown in FIG. 5c, an 802.11b connection is established and is prioritized since it always has an active connection, which renders the call set time minimal. Further, the user makes a VoIP call and the call priority table is updated, as shown in FIG. 5d. As shown, due its available connection, the 802.11b preserves its higher priority even though its QoS is lower than the one detected during the previous cellular voice call. In FIGS. 5e, the cellular voice connection has the highest fixed priority connection because of the manufacturer priority assignment for emergency calling. The remaining connections, however, are prioritized according their corresponding metrics. As for FIG. 5f, all of the connections have been assigned and follow a fixed, predetermined order.

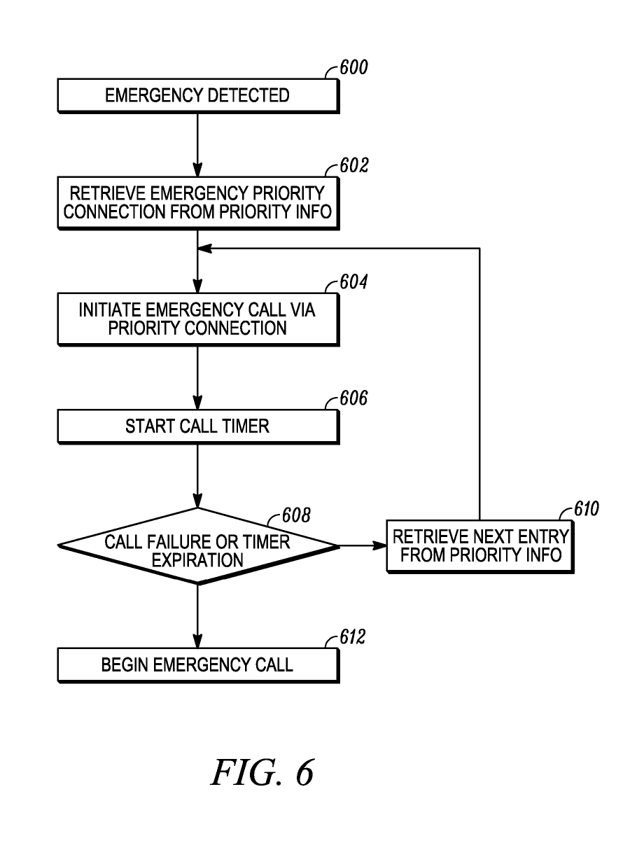

Now referring to FIG. 6, a flow chart illustrates a method for initiating an emergency call based on a current emergency call priority list of bearer services. Once an emergency is detected at step 600, the call initiating method is triggered. Subsequently, at step 602, the method retrieves the emergency priority connection from the call priority table stored in the confirmation file 312, and proceeds to initiate an emergency call via the retrieved priority connection, at step 604. Thus, the method proceeds to transmit the emergency call over a first bearer service that corresponds to the retrieved priority connection. Moreover, at step 604, the method may comprise a single attempt to transmit the emergency message or several attempts for a predetermined number of times. Accordingly, the method may start a call timer or an attempt counter, at step 606. The method determines, at step 608, whether the attempt to transmit the emergency message over the first bearer service was successful or timed out. To determine whether the emergency call transmission was successful, the service center 14 may send an acknowledgement message after receiving the emergency message from the client device 11. As such, at step 608, the method may include a monitoring function that may determine whether an acknowledgement message was received from the service center 14. In addition, the client applications 302 may determine if the expected signaling is being received from the network. If the emergency call was successfully setup to the service center 14, then the method ends, at step 612. Otherwise, the method proceeds to retrieve the second or next connection entry from the call priority table, at step 610, and begins to attempt to transmit the emergency call over the second bearer service that corresponds to the second retrieved priority connection.

In another embodiment, diagnostics facilities (not shown) in the vehicle 13 may detect and report damage occurring to the wireless units 112a-112d. As such, the proposed method may update the call priority tables using inputs from the diagnostics facilities, so that inaccessible communication connections are tagged as unavailable so as to be bypassed in emergencies.

Hence, once an emergency situation arises, this method may select the highest priority connection from the emergency call priority table for placing the emergency call. If the call should fail, due to damage inflicted by the emergency situation, or otherwise, this method may select the next highest priority connection to place the emergency call, transparent to the user. The emergency call priority table may not have been updated to remove or de-prioritize the failing interface after the emergency situation, as mentioned earlier, due to undetectable damage to the connection interfaces, or damage to the diagnostic entities. In some embodiments, the client device 11 may notify the user which connection is being used for the emergency call, and provide provisions for the user to override the choice. Moreover, other call attributes may be added to the priority table to help determine and prioritize the emergency connections. In addition to the prioritizing of the emergency call priority table, default and permanent configuration of the emergency call priority table may be provided by the original or alternate manufacturers. The emergency call method is also configurable, such as the expiration time of the call timer. Accordingly, this method enhances the emergency calling capabilities of a vehicle, home or office by prioritizing and utilizing alternate, or backup, connections to provide more reliable and faster emergency voice calling capabilities, whether to a service center or E911. The method constantly monitors the different access points that may be used as an emergency connection for quality of service and connection times, and possibly other attributes (availability). In doing so, the priority of the emergency connections is established. In addition, the manufacturer may specify that the highest priority connection mechanism should always be an E911 cellular call.

This method may be used for Vehicle Telematics systems, homes, office in emergency situations where multiple voice bearer services are available, whether over land-lines, cellular, WLAN, or Bluetooth. The method may extend to all Hands Free systems that do not have service centers or advanced Telematics capabilities.

The above described method may be performed by the application a processor using instructions that may reside on a computer-readable medium. The computer-readable medium may be any suitable computer readable storage medium such as, but not limited to random access memory, read-only memory, flash memory, CDROM, DVD, solid-state memory, magnetic memory, optical memory, and the like.

It is therefore intended that the foregoing detailed description be regarded as illustrative rather than limiting, and that it be understood that it is the following claims, including all equivalents, that are intended to define the spirit and scope of this invention.

1. A method for dynamically building and maintaining call priority information for use in emergency calls from a client device to an emergency call center, the method comprising the steps of:
providing a plurality of communication connections operable on at least one communication system, each of the plurality of communication connections corresponding to a plurality of bearer services and comprising a plurality of metrics;
determining by the client device which of the plurality of communication connections is active;
evaluating each of the plurality of metrics for each of the active communication connections; and
ordering sequentially the plurality of active communication connections based on at least one of the plurality of evaluated metrics.

2. The method for dynamically building and maintaining call priority information of claim 1, wherein the plurality of bearer services comprises at least one of cellular voice service, 802.11b service, global system for mobile communications service, Bluetooth service, general packet radio service, short message service, and circuit switched data service.

3. The method for dynamically building and maintaining call priority information of claim 1, wherein the plurality of metrics comprises at least one of quality of service, active connection availability, and connection time.

4. The method for dynamically building and maintaining call priority information of claim 1, wherein the sequential order of communication connections is configurable.

5. The method for dynamically building and maintaining call priority information of claim 1, wherein the step of determining which of the plurality of communications connections is active is continuously or regularly executed during runtime or after predetermined events.

6. The method for dynamically building and maintaining call priority information of claim 5, wherein the predetermined events comprise collisions, damaging events, and loss of communication connections.

7. The method for dynamically building and maintaining call priority information of claim 1, wherein the step of evaluating each of the plurality of metrics comprises:
initiating test calls; and
updating metrics on each of the active communication connections from the client device to the emergency call center.

8. The method for dynamically building and maintaining call priority information of claim 1, wherein the step of evaluating each of the plurality of metrics comprises gathering metrics during actual calls.

9. The method for dynamically building and maintaining call priority information of claim 1 further comprising retrieving each step from a computer readable medium, each step comprising a set of instructions which when executed by a computer system causes the computer system to implement the each step.

10. A method for communicating an emergency call from a client device to a service center, the method comprising the steps of:
providing a sequentially ordered plurality of communication connections, the plurality of communication connections corresponding to a plurality of bearer services;
attempting to transmit the emergency call over a first communication connection selected from the prioritized plurality of communication connections;
determining whether the emergency call was successfully transmitted to and received by the service center over the first communication connection;
attempting to transmit the emergency call over a second communication connection selected from the sequentially ordered plurality of communication connections if the service center did not receive the emergency message transmitted over the first communication connection;
determining whether the emergency call was successfully transmitted to and received by the service center over the second communication connection; and
sequentially traversing the plurality of communication connections until the emergency call is successfully transmitted to and received by the service center.

11. The method for communicating an emergency call from a client device to a service center of claim 10, wherein the emergency call comprises a voice call, a data call, or a combination of voice and data.

12. The method for communicating an emergency call from a client device to a service center of claim 10, wherein the plurality of bearer services comprises at least one of cellular voice service, 802.11b service, global system for mobile communications service, Bluetooth service, general packet radio service, short message service, and circuit switched data service.

13. The method for communicating an emergency call from a client device to a service center of claim 10, the prioritized plurality of communication is configured based on a plurality of metrics.

14. The method for communicating an emergency call from a client device to a service center of claim 10, wherein the plurality of metrics comprises at least one of QOS, active connection availability, or connection time.

15. The method of claim 10 further comprising the step of retrieving each step from a computer readable medium, each step comprising a set of instructions which when executed by a computer system causes the computer system to implement each step.

16. An apparatus for use in communication of emergency calls to a service center, the apparatus comprising:
a microcomputer operable to communicate information with the service center;
a plurality of wireless units, each in communication with the microcomputer and operable to transmit and receive information over a plurality of communication connections;
a modem in communication with the microcomputer and operable to support communication of information over analog wireless networks;
an emergency button in communication with the microcomputer and operable to initiate a generation of the emergency calls;
a position unit in communication with the microcomputer and operable to determine and report a position of the apparatus or a physical host of the apparatus; and
communication units in communication with the microcomputer and operable to provide and receive audio and visual information from a user.
